(19) United States
(12) Patent Application Publication
(10) Pub. No.: US 2026/0105425 A1
(43) Pub. Date: Apr. 16, 2026

(54) Systems and Methods for Processing Payments

(71) Applicant: VICTOR TECHNOLOGIES, INC., FAIRMONT, WV (US)

(72) Inventors: Charles Crupper, Eugene, OR (US); Mafoday Sonko, Cave Springs, AR (US); Bashar Abdul Jawad, Chandler, AZ (US)

(21) Appl. No.: 19/358,214

(22) Filed: Oct. 14, 2025

Related U.S. Application Data
(60) Provisional application No. 63/707,177, filed on Oct. 14, 2024.

(51) Int. Cl. G06Q 20/10

(52) U.S. Cl. CPC G06Q 20/10

(57) ABSTRACT

There are disclosed systems and methods for processing financial transactions in real time using a centralized online banking infrastructure for accurate, real-time transfers and ledger updates. The system is configured to execute the code to receive a transaction input comprising a payment account number, transaction identification (ID), and transaction time. The processor identifies a payment account using the destination account number and transaction ID, moves transaction funds to a settlement account, and records an entry in a centralized online real-time environment ledger of a bank to adjust the account balance. An inbound transaction notification is transmitted to a transaction engine, which returns instructional input for handling the funds.

The system records the transaction in a payor account ledger, moves the funds from a payment transit account to an operating account associated with the recipient, and updates the balance of the payment account in real time based on the recorded payment.

### RELATED APPLICATION(S)

The present application claims the benefit of and priority to a U.S. Provisional Patent Application Ser. No. 63/707,177, filed Oct. 14, 2024, which is hereby incorporated by reference in its entirety into the present application.

### BACKGROUND

The current state of the art for ledger reconciliation and payment processing among financial institutions teaches is that the preferred methodology for managing electronic payments involves a centralized ledger managed on a side centralized online real-time environment (CORE) separate from the financial institution, rather than on the institution's CORE. This system of centralized ledgers managed on side COREs spans across multiple banks and institutions.

These accepted, existing models require complicated reconciliation activities that result in compliance short-comings, lawsuits, and, in some cases, lost customer funds.

The existing solutions are made for branch-banking and are not compatible with interconnected electronic payment systems.

### SUMMARY

The present disclosure is directed to systems and methods for processing electronic payments, substantially as shown in and/or described in connection with at least one of the figures, as set forth more completely in the claims.

In some implementations, the disclosed system comprises a non-transitory memory storing an executable code, and a hardware processor executing the executable code to receive a transaction input, wherein the transaction input includes a payment account number, a transaction identification (ID), and a transaction time, identify a payment account based on the destination account number in the transaction input and the transaction ID, move funds associated with the transaction input to a transaction settlement account, record an entry in a bank transaction ledger adjusting the balance of the payment account based on the funds associated with the transaction input, wherein the bank transaction ledger is stored in a centralized online real-time environment (CORE) of a bank, transmit an inbound transaction notification to a transaction engine based on the transaction input, receive an instructional input from the transaction engine regarding the funds associated with the transaction input, record, using the transaction engine, the transaction associated with the transaction input is a payor account ledger, move the funds associated with the transaction input from the payment transit account into an operating account associated with a recipient of the funds associated with the transaction input, and update, in real time, a balance of the payment account based on the recorded payment.

The present disclosure also incudes a method for execution by a system comprising a non-transitory memory and a hardware processor. In some implementations, the method comprises receiving, using the hardware processor, a transaction input, wherein the transaction input includes a payment account number, a transaction identification (ID), and a transaction time, identifying, using the hardware processor, a payment account based on the destination account number in the transaction input and the transaction ID, moving, using the hardware processor, funds associated with the transaction input to a payment transit account, recording, using the hardware processor, an entry in a bank transaction ledger adjusting the balance of the payment account based on the funds associated with the transaction input, wherein the bank transaction ledger is stored in a centralized online real-time environment (CORE) of a bank, transmitting, using the hardware processor, an inbound transaction notification to a transaction engine based on the transaction input, receiving, using the hardware processor, an instructional input from the transaction engine regarding the funds associated with the transaction input, recording, using the hardware processor, the transaction associated with the transaction input in a payor account ledger, moving, using the hardware processor, the funds associated with the transaction input from the payment transit account into an operating account associated with a recipient of the funds associated with the transaction input, and updating, using the hardware processor, a balance of the payment account based on the recorded payment in real time.

In some implementations, the transaction ID is one of an alphabetic code, a numeric code, and an alphanumeric code.

In some implementations, the bank transaction ledger is one of a general ledger and a virtual ledger.

In some implementations, the payment account is a virtual account.

In some implementations, the payment account is maintained on the CORE.

In some implementations, the transaction settlement account is one of a general ledger account or a For Benefit Of (FBO) account.

In some implementations, the payment account is an account For Benefit Of (FBO) a bank customer.

In some implementations, the transaction engine records all operations on the CORE ledger system of a financial institution.

### BRIEF DESCRIPTION OF THE DRAWINGS

FIG. 1 shows a diagram of an exemplary system for processing electronic payments, according to one implementation of the present disclosure; and

FIG. 2 shows a flowchart illustrating an exemplary method of processing electronic payments, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

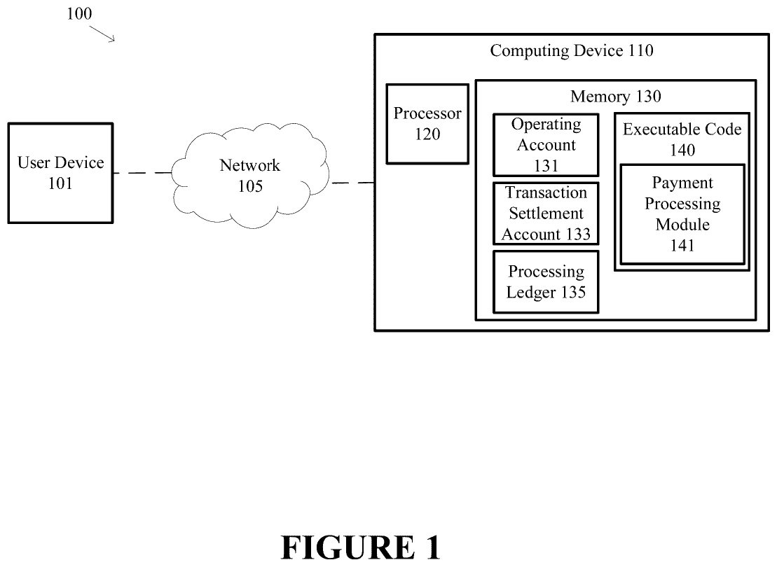

FIG. 1 shows a diagram of an exemplary system for processing electronic payments, according to one implementation of the present disclosure. System 100 includes user device 101, network 105, and computing device 110. User device 101 may be a user device used for initiating electronic payments, such as a computer cash register at a retail store, a server hosting an ecommerce website, or a mobile device such as a mobile phone or a tablet computer. In some implementations, user device 101 is a payment processing device used to initiate an electronic payment. Electronic payments may include credit card payments, debit card payments, electronic funds transfer (EFT) payments, peer-to-peer payments, or any other electronic payment method. User device 101 may connect to other computing devices through network 105. Network 105 is a computer network. In some implementations, network 105 may be a local area network, a wide area network, a wired network, a wireless network, or the internet. In some implementations, network 105 may be a cellular network or a mobile network.

In some implementations, computing device 110 may comprise a centralized online real-time environment (CORE) of a bank for transacting, recording, and processing transactions. In some implementations, computing device 110 may record transactions, be used to manage accounts for customers of a bank, perform actions related to loan processing, maintain bank customer data, record a general ledger for the bank. Computing device 110 may be used to record all debit and credit transactions for accounts held by the bank. Debit and credit transactions may include payments, withdrawals, and deposits, including any movement of money from an account held by the bank, any movement of money into an account held by the bank, and transfers of money between accounts held by the bank. In some embodiments, transfers of money between accounts held by the bank may include transfers of money between two or more accounts held by the same account holder or transfers between or among accounts held by two or more account holders. Computing device 110 is a computing system for processing electronic payments. As shown in FIG. 1, computing device 110 includes processor 120 and memory 130. Processor 120 is a hardware processor, such as a central processing unit (CPU) found in computing devices. Memory 130 is a non-transitory storage device for storing computer code for execution by processor 120, and also for storing various data and parameters. As depicted in FIG. 1, memory 130 includes operating account 131, transaction settlement account 133, processing ledger 135, and executable code 140. The accounts may be accounts held by the financial institution for a client and may be held on the general ledger of the financial institution. In some implementations, the accounts may be virtual accounts that are created and stored on the CORE of the financial institution for processing and reconciliation purposes. The processing ledger may be a ledger to record transactions for real-time transaction processing. The processing ledger may allow the financial institution records to be a transparent record of all transactions. The real-time accuracy of the processing ledger means that the accounts maintained on the CORE of the financial institution are true and accurate, providing verified and correct information about the balance of accounts at the financial institution.

Operating account 131 may be a bank account held by a financial institution, such as a bank. In some implementations, operating account 131 may be a checking account, a savings account, a money market account, or other bank account for liquid assets used to transact day-to-day business. Operating account 131 may be a bank account held by a bank for an individual or entity that receives payments.

Transaction settlement account 133 may be a bank account held by a bank. In some embodiments, transaction settlement account 133 may be an account used to temporarily hold funds received as the result of a financial transaction, the recipient of which is the owner of an account at the bank, such as operating account 131. In some implementations, transaction settlement account may be an account held for a particular type of transaction, such as an account for Automated Clearing House (ACH) transactions, an account for wire transfers, an account for credit card transactions, etc. In some embodiments, memory 130 may include a plurality of transaction settlement accounts for different types of transactions. Each transaction settlement account may be associated with a bank client. In other implementations, memory 130 may have one transaction settlement account for each type of transaction and may use a virtual ledger system for tracking transactions through transaction settlement account 133.

Processing ledger 135 is a ledger for recording transactions. In some implementations, processing ledger may be a spreadsheet, a database, a financial ledger, an Open Financial Exchange (OFX) file, a Quicken Financial Exchange (QFX) file, QuickBooks Online (QBO) file, a Quicken Interchange Format (QIF) file, an ISO 20022 XML file, a BAI2 file, a SWIFT MT file, a NACHA file, an Electronic Data Interchange (EDI) file, or other appropriate transaction ledger type. Processing ledger 135 may be a ledger for recording transactions on the CORE of a financial institution to allow the recordation of transactions in real time. Real-time recordation of transaction may allow for real-time reconciliation at the transaction level, allowing the CORE of the financial institution to be the ground truth for account balance and transactions.

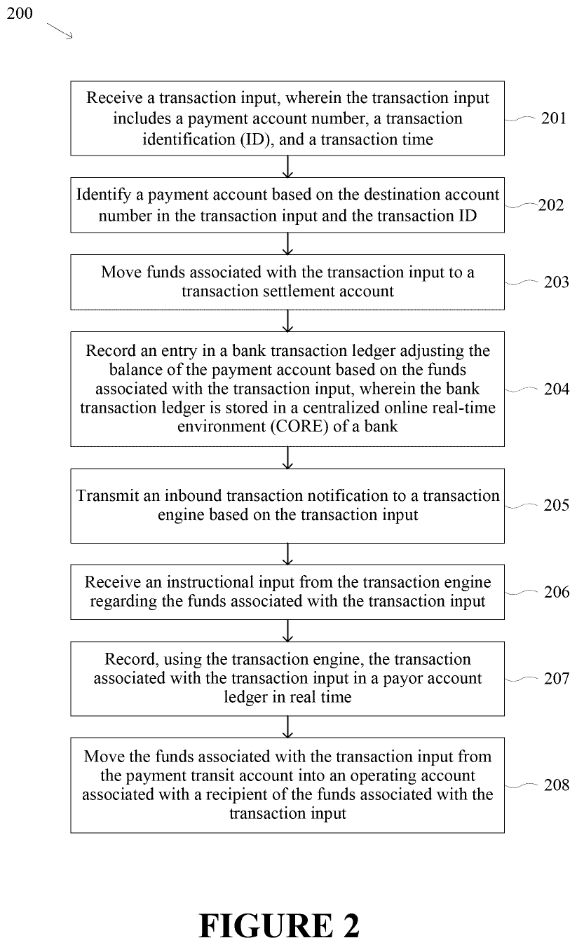

Executable code 140 may include one or more software modules for execution by processor 120, such as payment processing module 141. Payment processing module 141 is a software module stored in memory 130 for execution by processor 120 to process electronic payments. Payment processing module 141 is an algorithm for receiving recording payments, and for tracking payments in real time in the CORE of a bank or financial institution. Steps in the algorithm of payment processing module 141 are described in the flowchart of FIG. 2. In some implementations, payment processing module 141 may run on the CORE of a bank. In other implementations, payment processing module 141 may run on a service provider's server and engage with the CORE of the bank via a computer network, such as an intranet connecting numerous branches of a banking institutions to a centralized CORE.

FIG. 2 shows a flowchart illustrating an exemplary method of processing electronic payments, according to one implementation of the present disclosure. Process 200 begins at step 201 where computing system 110 receives a transaction input from client device 101. The transaction input may include payment information used to accurately and efficiently process the payment. In some implementations, the payment information may include a payment account number, an account type, a transaction identification (ID), and a transaction time. For processing purposes, the account type may indicate that the account is a virtual account, where a virtual account is an account operated by a financial institution for record keeping and reconciliation, but where the account is held on behalf of another entity or institution. The account type may be a “for benefit of” (FBO) account held by the financial institution. An FBO account is a financial account that a financial institution uses to manage funds on behalf of another entity or individual. The payment account number may be for the virtual account or FBO account maintained by the financial institution. The transaction ID may be a unique ID for each transaction ensuring complete, transparent, and traceable transactions in the system.

In some implementations, the transaction identifier may be an alphabetic code, a numeric code, and alphanumeric code, or other written code for identifying information about the transaction. For example, the transaction identifier may be a four-digit prefix to the payment information. In other implementations, the transaction identifier may be a suffix to the payment information, included as a defined portion of the payment information, or included as a field to the payment information. The transaction identifier may be used to identify a transaction type, such as the method of payment, or a destination account for the payment. The destination account may correspond to the payment type. In some implementations, the system may include a plurality of destination accounts for an account holder, including a destination account for each payment type. For example, the financial institution may have virtual accounts for a client including an account for credit card payments, an account for wire transfer payments, an account for ACH payments, and an account corresponding to each other type of payment that the client may receive.

At step 202, system 100, using processor 120, identifies a payment account based on the payment information. In some implementations, the payment information includes a destination account number and the transaction ID. The system may recognize that an electronic payment is being made to a destination account held by the financial institution based on the received electronic payment information. In some implementations, the destination account may be an account on a CORE ledger of the financial institution. In some implementations, the system's recognition may be based on the destination account number and the transaction identifier. In some implementations, the system's recognition may be based on the length of the destination account number, as well as the transaction identifier. In some implementations, the destination accounts may be virtual accounts operated by the financial institution.

At step 203, system 100, using processor 120, moves funds associated with the transaction input into a transaction settlement account associated with the identified payment account. The transaction settlement account may be maintained on the CORE ledger of the financial institution. In some implementations, the transaction settlement account may be a “For Benefit Of” (FBO) account or a general ledger account. In some implementations, the transaction settlement account is designated to receive a specific type of electronic payment, such as a wire transfer, an ACH transfer, or other form of electronic payment or transfer of funds. In some implementations, there is a second transaction settlement account on the CORE ledger. In some implementations, there are one or more transaction settlement accounts, all within the CORE ledger of the financial institution. In some implementations, the transaction settlement account may be a virtual account in the CORE. The virtual account may be designated by a virtual account identifier indicating the virtual account under a client's actual account. The virtual transaction settlement account may allow tracking and reconciliation of payments at a transaction level.

At step 204, system 100, using processor 120, records an entry in a bank transaction ledger adjusting the balance of the payment account based on the funds associated with the transaction input, wherein the bank transaction ledger is stored in the CORE of the financial institution. The adjustment to the balance of the payment account may result in real-time transaction processing and real-time verifiability of funds available in the payment account. In some implementations, the transaction ledger may be a virtual ledger in the CORE. A virtual ledger may be a transaction record maintained in the CORE to record and process transactions in real time. The virtual ledger may be a mirror of real ledger accounts used for digital processing of payments. In some implementations, the virtual ledger operates within the same database and transaction engine as the financial institution's physical accounts, enabling real-time updates to both virtual and real accounts, no batch delays, and complete traceability of all transactions.

At step 205, system 100, using processor 120, transmits an inbound transaction notification to a transaction engine based on the transaction input. In some implementations, the inbound transaction notification identifies the destination account of the inbound funds. The transaction engine may be integrated with the CORE ledger of the financial institution. In some implementations, the transaction engine is integrated via an application programing interface (API) with the CORE ledger of the financial institution. In some implementations, the transaction engine performs and records all operations on the CORE ledger of the financial institution. The CORE ledger may be a virtual ledger. In some implementations, the transaction engine interfaces with one or more accounts. The accounts may be virtual accounts.

In response to receiving the inbound transaction notification, transaction engine may process the inbound transaction notification and determine that the inbound transaction indicates a transfer of funds into an account held by the financial institution. The transaction engine may identify a settlement account, such as settlement account 133, associated with the transfer and a destination account, such as operating account 131, associated with the payment. The transaction engine may transmit an instruction to the CORE of the bank to transfer the payment amount from the transaction settlement account to the recipient's operating account.

At step 206, system 100, using processor 120, receives an instructional input from the transaction engine regarding the funds associated with the transaction input. In some implementations, the instructional input may be received via an API and direct deposit of funds from the transaction settlement account into an operating account of a client that holds its account with the receiving financial institution.

At step 207, system 100, using processor 120, records the transaction that corresponds with the transaction input in a payor account ledger in real time. The transaction engine credits the destination account with the electronic payment and updates the destination account with the value of the electronic payment and new balance on the CORE ledger. In some implementations, the ledger in which the transaction is recorded may be a virtual ledger. In some implementations, the account in which the transaction is recorded may be a virtual account.

At step 208, system 100, using processor 120, moves the funds associated with the transaction input from the transaction settlement account into an operating account associated with a recipient of the funds associated with the transaction input. The system, via the transaction engine, moves the electronic payment funds from the transaction settlement account to an operating account of the financial institution. In some implementations, the operating account is also maintained on the CORE ledger of the financial institution. In some implementations, the operating account may be a For Benefit Of account. In some implementations, the operating account may be a general ledger account.

The system maintains records of all such electronic payments received, and the distribution of the electronic payments to the associated destination accounts. By operating in the manner described above, the system ensures a single source of truth for records of all electronic payments, minimizing current issues faced in both reconciliation of transaction data and compliance with the regulatory framework under which financial institutions operate.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system comprising:
a non-transitory memory storing an executable code; and
a hardware processor executing the executable code to:
receive a transaction input, wherein the transaction input includes a payment account number, a transaction identification (ID), and a transaction time;
identify a payment account based on the destination account number in the transaction input and the transaction ID;
move funds associated with the transaction input to a transaction settlement account;
record an entry in a bank transaction ledger adjusting the balance of the payment account based on the funds associated with the transaction input, wherein the bank transaction ledger is stored in a centralized online real-time environment (CORE) of a bank;
transmit an inbound transaction notification to a transaction engine based on the transaction input;
receive an instructional input from the transaction engine regarding the funds associated with the transaction input;
record, using the transaction engine, the transaction associated with the transaction input is a payor account ledger;
move the funds associated with the transaction input from the payment transit account into an operating account associated with a recipient of the funds associated with the transaction input; and
update, in real time, a balance of the payment account based on the recorded payment.

2. The system of claim 1, wherein the transaction ID is one of an alphabetic code, a numeric code, and an alphanumeric code.

3. The system of claim 1, wherein the bank transaction ledger is one of a general ledger and a virtual ledger.

4. The system of claim 1, wherein the payment account is a virtual account.

5. The system of claim 1, wherein the payment account is maintained on the CORE.

6. The system of claim 1, wherein the transaction settlement account is one of a general ledger account or a For Benefit Of (FBO) account.

7. The system of claim 1, wherein the payment account is an account For Benefit Of (FBO) a bank customer.

8. The system of claim 1, wherein the transaction engine records all operations on the CORE ledger system of a financial institution.

9. A method for execution by a system comprising a non-transitory memory and a hardware processor, the method comprising:
receiving, using the hardware processor, a transaction input, wherein the transaction input includes a payment account number, a transaction identification (ID), and a transaction time;
identifying, using the hardware processor, a payment account based on the destination account number in the transaction input and the transaction ID;
moving, using the hardware processor, funds associated with the transaction input to a payment transit account;
recording, using the hardware processor, an entry in a bank transaction ledger adjusting the balance of the payment account based on the funds associated with the transaction input, wherein the bank transaction ledger is stored in a centralized online real-time environment (CORE) of a bank;
transmitting, using the hardware processor, an inbound transaction notification to a transaction engine based on the transaction input;
receiving, using the hardware processor, an instructional input from the transaction engine regarding the funds associated with the transaction input;
recording, using the hardware processor, the transaction associated with the transaction input in a payor account ledger;
moving, using the hardware processor, the funds associated with the transaction input from the payment transit account into an operating account associated with a recipient of the funds associated with the transaction input; and
updating, using the hardware processor, a balance of the payment account based on the recorded payment in real time.

10. The method of claim 9, wherein the transaction ID is one of an alphabetic code, a numeric code, and an alphanumeric code.

11. The method of claim 9, wherein the bank transaction ledger is one of a general ledger and a virtual ledger.

12. The method of claim 9, wherein the payment account is a virtual account.

13. The method of claim 9, wherein the payment account is maintained on the CORE.

14. The method of claim 9, wherein the transaction settlement account is one of a general ledger account or a For Benefit Of (FBO) account.

15. The method of claim 9, wherein the payment account is an account For Benefit Of (FBO) a bank customer.

16. The method of claim 9, wherein the transaction engine records all operations on the CORE ledger system of a financial institution.
